(19) United States
(12) Patent Application Publication
(10) Pub. No.: US 2018/0223578 A1
(43) Pub. Date: Aug. 9, 2018

(54) LOCKING DEVICE

(71) Applicant: Geze GmbH, Leonberg (DE)

(72) Inventor: Matthias Hucker, Marxzell (DE)

(21) Appl. No.: 15/889,889

(22) Filed: Feb. 6, 2018

(30) Foreign Application Priority Data
Feb. 8, 2017 (DE) DE 102017201939.5

(51) Int. Cl. E05F 3/22; E05F 15/60; H02K 7/102; H02K 11/30; H02K 51/00

(52) U.S. Cl. CPC E05F 3/222; E05F 15/60; H02K 7/1023; H02K 11/30; H02K 51/00; E05Y 2900/134; E05Y 2201/21; E05Y 2201/434; E05Y 2400/20; E05Y 2400/52; E05Y 2400/616; E05Y 2201/218

(57) ABSTRACT

A device for locking a leaf of a door or the like comprising at least one electric motor operated as a generator having a motor shaft which is operatively connected to the leaf via a force transmission unit. The motor terminals of at least one electric motor operated as a generator are connected in this regard to a damping circuit for damping the leaf movements. The motor shaft of at least one electric motor operated as a generator is acted on by a brake unit to lock the leaf.

The invention relates to a device for locking a leaf of a door or the like, comprising at least one electric motor operated as a generator having a motor shaft which is operatively connected to the leaf via a force transmission unit. The invention further relates to a door closer comprising such a locking device.

Door closers for movable door leaves comprising a mechanical energy store and a damping device for damping the leaf movement are generally known. During manual opening of the door leaf, the mechanical energy store is charged with potential energy, which then again closes the released door leaf. The mechanical energy store may, for example, comprise a spring which is tensioned by the manual opening of the door leaf and is released again by closing of the door leaf.

There are already drives known for actuating a movable door leaf, comprising a damping device for damping the leaf movement, said drives comprising an electric motor operated as a generator having a motor shaft which is rotatable by a movement of the door leaf, wherein a motor voltage, which is applied to a damping circuit and is dependent on the movement, is generated at the motor terminals thereof. The damping circuit can have at least one switching element designed, for example, as a field effect transistor, via which the motor terminals can be short-circuited. A drain source path of the field effect transistor is arranged in the damping circuit. A voltage is set between the gate and the source of the field effect transistor via a potentiometer that is connected in parallel with the drain source path of the field effect transistor. A voltage tap of the potentiometer is connected to the gate terminal of the field effect transistor. The field effect transistor is thus operated as a voltage-dependent load resistor for the electric motor so that the damping force of the damping device is a function of the output voltage of the electric motor operated as a generator.

Locking devices are also already known, by means of which a door leaf is lockable at certain opening angles. However, in particular, in the case of door openers which have a mechanical store comprising a spring unit and a generator motor having motor terminals which are connected to a damping circuit for damping the leaf, there exists the problem that, owing to electrical losses, the damping motor can only damp the movement of the door leaf during closing. However, it is not able to stop the movement, i.e., lock it. As long as the spring force of the mechanical store is greater than the friction, the spring force itself will then slowly continue to move the door leaf when the damping motor is completely short-circuited.

The underlying object of the invention is to define a locking device and a door closer of the aforementioned type by means of which the previously mentioned problems are eliminated. In particular, a reliable locking of the door is to be realized as a result with the most efficient use of the damping, generated by a drive, of the door movement by means of already present components in the simplest and, accordingly, most cost-effective manner.

According to the invention, this problem is solved by a locking device having the features of claim 1 and a door closer having the features of claim 18. Preferred embodiments of the locking device according to the invention and the door closer according to the invention arise from the dependent claims.

The device according to the invention for locking a leaf of a door or the like comprises at least one electric motor operated as a generator having a motor shaft which is operatively connected to the leaf via a force transmission unit. In this regard, the motor terminals of at least one electric motor operating as a generator are connected to a damping circuit for damping the leaf movements. To lock the leaf, the motor shaft of at least one electric motor operating as a generator is acted on by a brake unit.

Owing to this design, a reliable locking of the leaf is guaranteed in a simple and, accordingly, inexpensive manner, wherein the components provided in a drive with generative damping of the leaf movements are used efficiently.

The brake unit preferably comprises an electromagnetic brake.

According to one preferred practical embodiment of the locking device according to the invention, the locking device comprises an evaluation and/or control unit, via which the brake unit can be actuated. A variable setting of the locking, in particular, a time-limited locking and/or the like is possible via such an evaluation and/or control unit.

It is advantageous, in particular, if at least one electric motor operated as a generator is connected via the motor terminals thereof to a charging circuit, via which the evaluation and/or control unit can be supplied with electrical energy. Possible autonomous operation of the locking device, that is, without an external energy supply, is thus guaranteed.

The brake unit can be operated in a monostable manner, for example, according to the open-circuit principle. The brake unit in the idle state, or when a control signal is not present, can, in this regard, act on the at least one relevant motor shaft for locking the leaf. As soon as a control signal is provided or, at the latest, as soon as an energy store charged via the charging circuit is empty, then the brake unit is released.

According to one alternative embodiment, the brake unit can also be operated in a bistable way. This provides the advantage, inter alia, that power is required from the energy store only during switching times. In this regard, it might be expedient if the evaluation and/or control unit monitors the energy store, which is chargeable via the charging circuit, in order to be able to release the locking of the leaf at the right time, as necessary, if the energy stored in said energy store is insufficient.

According to one preferred practical embodiment of the locking device according to the invention, this comprises at least two electric motors operated as generators, of which one is connected via the motor terminals thereof to the damping circuit and the other is connected via the motor terminals thereof to the charging circuit. In this case, the one electric motor thus functions as a damping motor for damping the leaf movements and the other electric motor functions as a generator motor for generating the power necessary for charging the energy store via the charging circuit.

In order to lock the leaf, the motor shaft of the electric motor connected to the charging circuit via the motor terminals thereof and/or the motor shaft of the electric motor connected to the damping circuit via the motor terminals thereof can be acted on by the brake unit.

It is also particularly advantageous if the damping circuit is controllable via the evaluation and/or control unit.

The damping circuit preferably in this regard comprises at least one switch element actuable via the evaluation and/or control unit, and a pulse-width modulation of the motor current can be carried out via said switch element. The pulse-width modulation of the motor current enables, in an advantageous manner, a closing time to be specified, which can be held constant, for example, by controlling the closing speed as a function of the opening angle of the door leaf. The desired closing time can be specified and set in an advantageous manner independent of temperature, deterioration, or friction.

The brake unit can preferably be actuated via the evaluation and/or control unit to generate a time-limited locking of the leaf.

According to one expedient practical embodiment of the locking device according to the invention, the brake unit is actuable via the evaluation and/or control unit for setting a predefined delayed closing action of the leaf. In the case of a door closer, the opened leaf can thus close only after a certain time. It can therefore take into account the fact that passage through the door requires some time, for example, to transport larger objects through the door. If several persons want to pass through the door, then more time is likewise required, during which the door should be held open.

According to another advantageous embodiment of the locking device according to the invention, the brake unit is actuable via the evaluation and/or control unit according to output signals from a safety sensor system.

If, for example, a person is endangered by the closing of the door leaf, then the door leaf can be stopped for at least a short time so that the person can remove themselves from the hazardous area.

According to another preferred practical embodiment of the locking device according to the invention, in the case of a two-leaf door comprising one fixed leaf and one through-passage leaf, at least one electric motor operated as a generator is associated with the two leaves in each case, and to lock the two leaves, the motor shaft of an electric motor associated with a leaf in each case can be acted on by a brake unit.

The closing sequence of the two leaves can be controlled and/or regulated in the process via the evaluation and/or control unit.

Therefore, in particular, a two-leaf fire door can be equipped with a locking device according to the invention or with corresponding door closers according to the invention. If the fixed leaf is opened while the through-passage leaf closes, then the through-passage leaf should interrupt the closing process at least until the fixed leaf is again closed farther than the through-passage leaf. Conversely, the fixed leaf should be automatically actuated in the case that the through-passage leaf is manually actuated.

According to another advantageous embodiment of the locking device according to the invention, in the case of a leaf of a fire door or the like, the brake unit associated with the leaf can be actuated via the evaluation and/or control unit such that a locking of the leaf is released in the case of fire.

The locking can again be carried out in a monostable or bistable manner according to the open-circuit principle. In the case of a monostable embodiment, a brake unit can be released as soon as a control signal is received from a fire detector, however, at the latest as soon as the energy store chargeable via the charging circuit is empty. A bistable embodiment provides the advantage, as already mentioned, that power is required from the energy store only during switching times. The charging state of the energy store is advantageously monitored via the evaluation and/or control unit in order to be able to release the locking at the correct time as long as the energy stored in the energy store remains sufficient.

The at least one brake unit can thus be actuated via the evaluation and/or control unit in particular for setting a predefined delayed closing action and/or according to output signals from a safety sensor system and/or for controlling and/or for regulating the closing sequence in the case of a two-leaf door and/or for releasing a leaf of a fire door in the case of fire.

For locking a leaf according to the invention, at least one, for example, electromagnetic brake unit can be provided for acting on at least one motor shaft of at least one electric motor operated as a generator. Owing to the generally high reduction ratio of a transmission associated with an electric motor, the smallest torques are sufficient for holding the spring unit constituting the energy store. As already mentioned, a brake unit can be designed as monostable or bistable.

If a door closer provided comprising a locking device according to the invention is to fundamentally function with a delayed closing action, then no external signal is necessary. The delayed closing action can be entered as a parameter into a data memory, for example, using near field communication (NFC). The leaf closes following expiration of the time predefined by the evaluation and/or control unit, or as soon as the energy store, chargeable via the charging circuit, is empty. For longer times, the energy in the energy store can be increased using an additional battery or an accumulator.

Alternatively or additionally, the delayed closing action can also be controlled via a signal. In the simplest case, a switch or the like can be provided to switch the fixed delay on and off. The delayed closing action can also be controlled via a sensor system (for example, passive infrared sensors). In this case, the leaf can stay open, for example, for as long as persons, who wish to pass through the door, are detected by the sensor system. In this case as well, an additional accumulator or a battery can be used for the longest delay times. Such embodiments are also conceivable in which the sensor system is provided with its own battery and/or its own accumulator. A corresponding sensor system can also be integrated in a door closer for this purpose.

If a brake unit can be actuated via the evaluation and/or control unit as a function of output signals from a safety sensor system, then, for example, the movement surface can be secured, for example, like a secondary closing edge of the leaf. The relevant sensor system can be provided with its own battery or its own accumulator.

If the leaf is open and the sensor system provides an active signal, then the leaf can be held open according to a predefined delayed closing action. If the sensor system provides an active signal during the closing of the leaf, then the evaluation and/or control unit can initially damp the leaf with a maximum damping, i.e., at a pulse-width modulation of 100%, and can subsequently additionally activate the at least one brake unit for locking the leaf counter to the force of the spring unit.

For controlling and/or regulating the closing sequence in the case of a two-leaf door, the energy stores associated with the two door leaves can be coupled. Thus, in particular, sufficient energy is always supplied for switching a bistable locking, in that the two leaves of the two-leaf door are actuated such that the one leaf is always moved when the locking of the other has to be delayed. If the fixed leaf and the pass-through leaf are both open, for example, and the fixed leaf is manually released so that it closes, then the locking of the through-passage leaf can be released shortly before the fixed leaf reaches the closed position. If, in contrast, the through-passage leaf is released when the two leaves are open, then the locking of the fixed leaf can be directly released. If the fixed leaf is opened while the through-passage leaf closes, then the through-passage leaf can be stopped until the fixed leaf is again closed farther than the through-passage leaf.

According to the invention, an autonomous electric closing sequence can also be realized for door closers with generative damping.

An electric motor operated as a generator can be designed in particular as a permanently magnetically excited DC motor.

The door closer according to the invention comprises a mechanical energy store, which is chargeable with potential energy by manually opening the door leaf, said energy being able to be used for closing the door leaf, and a locking device. It is characterized in that the locking device is designed according to the invention.

The invention is subsequently explained in greater detail with reference to the drawing. The single FIGURE shows, in schematic representation, an exemplary embodiment of a device 10 according to the invention for locking a leaf 12 of a door or the like. In the present case, this is, for example, a leaf 12 of a swing door.

Locking device 10 comprises at least one electric motor 14, 16 operated as a generator, having a motor shaft which is connected to leaf 12 via a force transmission unit such that a movement of leaf 12 is accompanied by a movement of the motor shaft. The force transmission unit can in this regard also, inter alia, comprise in particular a transmission 18, 20.

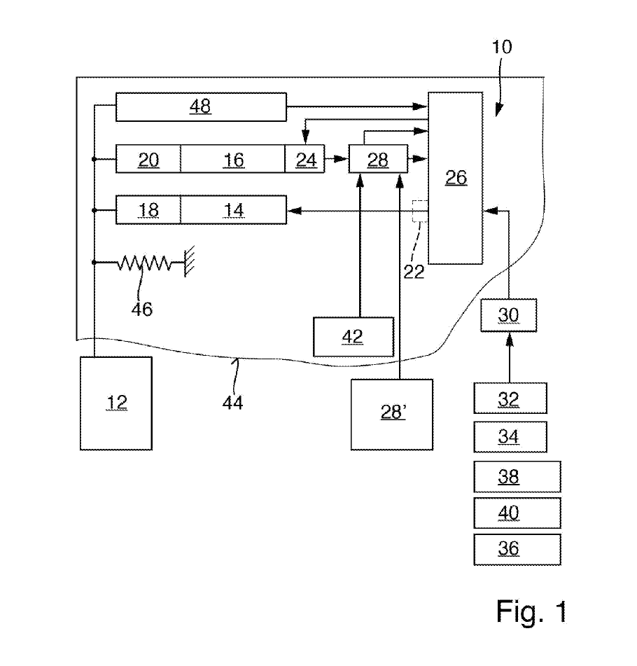

The motor terminals of at least one electric motor 14, 16 operated as a generator are connected to a damping circuit 22 for damping the leaf movements, wherein only the motor terminals of electric motor 14 are connected to such a damping circuit 22 according to the embodiment shown in the single FIG. 1. In the present case, only electric motor 14 of the two electric motors 14, 16 functions as a damping motor.

To lock leaf 12, the motor shaft of at least one electric motor 14, 16 operated as a generator can be acted on by a brake unit 24, wherein only the motor shaft of electric motor 16 is acted on by such a brake unit 24 according to the embodiment shown in FIG. 1. Brake unit 24 can comprise, in particular, an electromagnetic brake.

Locking device 10 comprises control electronics having an evaluation and/or control unit 46, via which brake unit 24 can be actuated.

At least one electric motor 14, 16 operated as a generator can be connected via the motor terminals thereof to a charging circuit for charging an energy store 28. In the embodiment shown in FIG. 1, only electric motor 16 is connected via the motor terminals thereof to such a charging circuit provided for charging energy store 28. The charging circuit is likewise part of the evaluation and control electronics of locking device 10, like the damping circuit and evaluation and/or control unit 26. However, damping circuit 22 in particular can also be integrated in evaluation and/or control unit 26.

Evaluation and/or control unit 26 can be supplied with electrical energy via the charging circuit or via energy store 28 which is chargeable via same. Thus, autonomous operation without an external supply of electrical energy is possible.

Brake unit 24 can be operated in either a monostable or bistable manner according to the open-circuit principle.

In the embodiment shown in FIG. 1, the locking device thus comprises two electric motors 14, 16 operated in each case as generators, of which one, namely electric motor 14, is connected via the motor terminals thereof to damping circuit 22, and the other, namely electric motor 16, is connected via the motor terminals thereof to the charging circuit for charging energy store 28.

In order to lock leaf 12, basically the motor shaft of electric motor 16, connected via the motor terminals thereof to the charging circuit, and/or the motor shaft of electric motor 14, connected via the motor terminals thereof to damping circuit 22, can be acted on by brake unit 24. Basically, such an embodiment is also conceivable in which such a brake unit is associated with each electric motor. In the embodiment shown in FIG. 1, only the motor shaft of electric motor 16, connected via the motor terminals thereof to the charging circuit for charging energy store 28, is acted on by a brake unit 24.

Damping circuit 22, which, like the charging circuit with associated energy store 28, is associated with the evaluation and/or control electronics, can be actuated via evaluation and/or control unit 26. As previously mentioned, damping circuit 22 can also be integrated in evaluation and/or control unit 26.

Damping circuit 22, connected to the motor terminals of electric motor 14 functioning as a damping motor can comprise at least one switching element, which can be actuated via evaluation and/or control unit 26, and via which a pulse-width modulation of the motor current can be carried out. The movement of leaf 12, in particular according to the position, speed, and/or direction of rotation of leaf 12, can be damped in the process by a corresponding short circuit, for example, via pulse-width modulation, of electric motor 14 functioning as a damping motor.

Brake unit 24 can be actuated via evaluation and/or control unit 26, in particular to generate a time-limited locking of leaf 12.

Brake unit 24 is can be actuated in the process via evaluation and/or control unit 26, for example, for setting a predefined delayed closing action of leaf 12.

Alternatively or additionally, brake unit 24 can also be actuated via evaluation and/or control unit 26 according to output signals from a safety sensor system.

Alternatively or additionally, in the case of a two-leaf door having one fixed leaf and one through-passage leaf, at least one electric motor 14, 16 operated as a generator can be associated in each case with the two leaves 12, and to lock the two leaves 12, the motor shaft of at least one electric motor 14, 16 associated in each case with one leaf 12 can be acted on by a brake unit 24. The closing sequence of the two leaves 12 can be controlled and/or regulated in the process via evaluation and/or control unit 26.

Alternatively or additionally, in the case of a leaf 12 of a fire door or the like, brake unit 24 associated with leaf 12 can also be actuable via evaluation and/or control unit 26 such that a locking of leaf 12 is released in the case of fire. This ensures that the leaf is closed by the associated mechanical store in the event of fire.

As can be seen from FIG. 1, evaluation and/or control unit 26 can actuate brake unit 24 and/or damping circuit 22 thus, for example, according to a signal 30, which can be predefined in the case of a delayed closing action, for example, by a switch 32 and/or a person detector 34 and/or by a safety sensor system 36, and/or in the case of a fire door by a fire alarm, and/or in the case of a two-leaf door having one fixed leaf and one through-passage leaf by a closing sequence specification 40 and/or the like.

In particular, for longer delay times, an additional accumulator or an additional battery 42 can also be provided to supply evaluation and/or control unit 26 with electrical energy. In the case of a two-leaf door, energy stores 28, 28′ of the locking devices or the door closers associated with the two leaves 12 can be coupled to one another. In particular, for switching a bistable locking, there is always sufficient electrical energy available when in each case a leaf is moved while the locking of the other has to be stopped, as this was already explained in detail at the outset.

As can also be seen from FIG. 1, locking device 10 according to the invention can be integrated, in particular, in a door closer 44 having a mechanical energy store 46 which is chargeable with potential energy by manually opening door leaf 12, said energy being able to be used to close door leaf 12. Mechanical energy store 46 of door closer 44 in this regard can comprise in particular a spring unit.

Using a locking device 10 according to the invention, a time-limited locking of a door leaf can thus be implemented for a generatively damped door closer, for example, for a delayed closing action in conjunction with a safety sensor, for a closing sequence for a two-leaf door, and/or according to at least one fire alarm. The generatively damped door closer can in this regard be provided with a monostable or bistable locking device and/or the locking is guaranteed to be supplied with electrical energy from an autonomous energy store.

In general, the leaf movement can be damped, in particular, as described in DE 10 2015 200 284 B3, the disclosure of which is incorporated herein.

Upon opening door leaf 12, the spring unit of mechanical energy store 46 is tensioned. At the same time, the two electric motors 14, 16 turn. Electric motor 16 functioning as a generator motor generates electrical energy via the charging circuit, which is stored in energy store 28, the status of which can be monitored by evaluation and/or control unit 26. Energy store 28 supplies evaluation and/or control unit 26 with electrical energy. The movements of leaf 12 are damped according to the position, speed, and or direction of rotation of leaf 12 by evaluation and/or control unit 26 via damping circuit 22, for example by a short circuit, using pulse width modulation, of the motor terminals of electric motor 14 functioning as a damping motor. The position, speed, and/or direction of rotation of leaf 12 can be detected via a corresponding measuring circuit 48 and transmitted to evaluation and/or control unit 26. For certain situations, a time-limited locking of leaf 12 is possible by a corresponding actuation, by evaluation and/or control unit 26, of brake unit 24, associated with electric motor 16 functioning as a generator motor.

### REFERENCE NUMERALS

10 Locking device
12 Leaf
14 Electric motor
16 Electric motor
18 Transmission
20 Transmission
22 Damping circuit
24 Brake unit
26 Evaluation and/or control unit
28 Energy store
30 Signal
32 Switch
34 Person detector
36 Safety sensor system
38 Fire alarm
40 Closing sequence
42 Additional accumulator/battery
44 Door closer
46 Mechanical energy store
48 Measuring circuit

1. A device (10) for locking a leaf (12) of a door or the like comprising at least one electric motor (14; 16) operated as a generator, having a motor shaft which is operatively connected to the leaf (12) via a force transmission unit, wherein the motor terminals of at least one electric motor (14; 16) operated as a generator are connected to a damping circuit (22) for damping the leaf movements, and the motor shaft of at least one electric motor (14; 16) operated as a generator is acted on by a brake unit (24) for locking the leaf (12).

2. The locking device according to claim 1 wherein the brake unit (24) comprises an electromagnetic brake.

3. The locking device according to claim 1 wherein the locking device (10) comprises an evaluation and/or control unit (26), via which the brake unit (24) can be actuated.

4. The locking device according to claim 3 wherein at least one electric motor (14; 16) operated as a generator is connected via the motor terminals thereof to a charging circuit, via which the evaluation and/or control unit (26) can be supplied with electrical energy.

5. The locking device according to claim 1 wherein the brake unit (24) can be operated in a monostable manner according to the open-circuit principle.

6. The locking device according to claim 1 wherein the brake unit (24) can be operated in a bistable manner.

7. The locking device according to claim 1 wherein the locking device (10) comprises at least two electric motors (14; 16) operated as generators, of which one is connected via the motor terminals thereof to the damping circuit (22) and the other is connected via the motor terminals thereof to the charging circuit.

8. The locking device according to claim 7 wherein in order to lock the leaf (12), the motor shaft of the electric motor (16), connected via the motor terminals thereof to the charging circuit, and/or the motor shaft of the electric motor (14), connected via the motor terminals thereof to the damping circuit (22), can be acted on by the brake unit (24).

9. The locking device according to claim 1 wherein
the damping circuit (22) can be actuated via the evaluation and/or control unit (26).

10. The locking device according to claim 9 wherein the damping circuit (22) comprises at least one switching element, which can be actuated via the evaluation and/or control unit (26) and via which a pulse-width modulation of the motor current can be carried out.

11. The locking device according to claim 1 wherein
the brake unit (24) can be actuated via the evaluation and/or control unit (26) to generate a time-limited locking of the leaf (12).

12. The locking device according to claim 1 wherein
the brake unit (24) can be actuated via the evaluation and/or control unit (26) for setting a predefinable delayed closing action of the leaf (12).

13. The locking device according to claim 1 wherein
the brake unit (24) can be actuated via the evaluation and/or control unit (26) according to output signals from a safety sensor system.

14. The locking device according to claim 1 wherein,
in the case of a two-leaf door having one fixed leaf and one through-passage leaf, at least one electric motor (14; 16) operated as a generator is associated in each case with the two leaves (12), and to lock the two leaves (12), in each case the motor shaft of at least one electric motor associated with a leaf (12) is acted on by a brake unit (24).

15. The locking device according to claim 14 wherein the closing sequence of the two leaves (12) can be controlled and/or regulated via the evaluation and/or control unit (26).

16. The locking device according to claim 14 wherein in the case of a two-leaf door having a fixed leaf and a through-passage leaf, the evaluation and control unit (26) is equipped with an additional accumulator or battery (42).

17. The locking device according to claim 1 wherein
in the case of a leaf (12) of a fire door or the like, the brake unit (24) associated with the leaf can be actuated via the evaluation and/or control unit (26) such that a locking of the leaf (12) is released in the event of fire.

18. A door closer (44) comprising a mechanical energy store (46) which is chargeable with potential energy by manually opening the door leaf, said energy being able to be used for closing the door leaf, and comprising a locking device, characterized in that the locking device (10) is implemented according to claim 1.
